(19) United States
(12) Patent Application Publication
(10) Pub. No.: US 2020/0064281 A1
(43) Pub. Date: Feb. 27, 2020

(54) A SYSTEM AND A METHOD FOR COMPOSITIONAL ANALYSIS

(71) Applicant: Sensinite Oy, Vaasa (FI)

(72) Inventors: Jan KARLSSON, Vaasa (FI); Risto ORAVA, Helsinki (FI)

(21) Appl. No.: 16/610,645

(22) PCT Filed: Apr. 27, 2018
(86) PCT No.: PCT/FI2018/050308

§ 371 Date: Nov. 4, 2019

(30) Foreign Application Priority Data
May 4, 2017 (GB) 1707089.7

(51) Int. Cl. G01N 23/207; G01N 23/2055; G01N 15/02

(52) U.S. Cl. CPC G01N 23/2073; G01N 23/2055; G01N 2223/305; G01N 2223/1013; G01N 2223/1016; G01N 15/0211

(57) ABSTRACT

A system (100) for producing analysis data indicative of presence of one or more predetermined components in a sample (110) is presented. The system includes source equipment (120) for directing a particle stream (130) towards the sample (110), detector equipment (140) for measuring a distribution of particles scattered from the sample (110) as a function of a scattering angle (θ), and processing equipment (170) for producing the analysis data based on the measured distribution of the scattered particles and on reference information indicative of an effect of the one or more predetermined components on the distribution of the scattered particles. The scattering angle related to each scattered particle is an angle between an arrival direction of the particle stream and a trajectory (160) of the scattered particle. The system utilizes different directional properties of scattering related to different isotopes, different chemical substances, and different isomers.

### FIELD OF THE DISCLOSURE

The disclosure relates generally to compositional analysis. More particularly, the disclosure relates to a system and to a method for producing analysis data indicative of presence of one or more predetermined components in a sample, e.g. isotopes, chemical substances, and/or isomers. Furthermore, the disclosure relates to a computer program for producing analysis data indicative of presence of one or more predetermined components in a sample.

### BACKGROUND

Traditionally, compositional analyses of materials are carried out to detect whether a sample of material contains one or more predetermined components and possibly to detect amounts of those of the components detected to be present. For example, material to be analysed can be a gaseous sample such as e.g. air that is analysed to determine presence of harmful gas components such as e.g. carbon monoxide and hydrogen sulphide. Various techniques are used to perform such analyses, including for example X-ray diffraction and electron diffraction. X-rays mainly undergo electromagnetic interactions with the atomic electrons, and effectively probe high-Z materials. In a case of low-Z materials, incident neutrons can be used to significantly improve material identification capabilities. As electrically neutral particles, neutrons interact directly with atomic nuclei and probe different isotope variates of elementals. X-ray and neutron interactions with material represent complementary ways for probing material composition.

Conventionally, analysis systems based on neutron interaction comprise a neutron source, such as a neutron generator, for directing a stream of neutrons towards a sample to be analysed. The neutrons that interact with atomic nuclei of the sample are detected and analysed to determine whether the sample contains one or more predetermined components such as isotopes which are under consideration. There is however a need to improve the accuracy of analysis systems based on neutron interaction as well as the accuracy of analysis systems based on interaction with particles other than neutrons. Furthermore, there is a need to extend the suitability of analysis techniques based on a particle stream to cases where different chemical substances and/or different isomer variates of chemical substances are to be detected.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new system for producing analysis data indicative of presence of one or more predetermined components in a sample. Each predetermined component can be for example an isotope variant of an elemental e.g. ¹²C, ¹³C, ¹⁴C, a chemical substance or compound such as e.g. glucose C₆H₁₂O₆, ethanol C₂H₅OH, methane CH₄, or an isomer variant of a chemical compound.

A system according to the invention comprises:
source equipment for directing a particle stream, e.g. a neutron stream, towards a sample to be analysed,
detector equipment for measuring a distribution of particles scattered from the sample as a function of at least a scattering angle, the scattering angle related to each scattered particle being an angle between an arrival direction of the particle stream and a trajectory of the scattered particle under consideration, and
processing equipment for producing the above-mentioned analysis data based on the measured distribution of the scattered particles and on reference information indicative of an effect of the one or more predetermined components on the distribution of the scattered particles.

The above-described system utilizes different directional properties of scattering related to different isotopes, different chemical substances and compounds, and different isomers. The above-mentioned distribution of the scattered particles indicates how much particles are scattered to different scattering directions i.e. how the scattering particles are distributed between different scattering angles.

In a system according to an advantageous and non-limiting embodiment of the invention, the processing equipment is configured to:
maintain a model for computationally simulating a scattering process where the particle stream is directed towards a simulation model sample having a simulation model composition of the predetermined components,
simulate the scattering process with the model and vary the simulation model composition of the predetermined components until a difference between a simulated distribution of scattered particles and the measured distribution of the scattered particles fulfil a predetermined criterion, and
set the analysis data to be the simulation model composition with which the predetermined criterion is fulfilled.

In accordance with the invention, there is provided also a new method for producing analysis data indicative of presence of one or more predetermined components in a sample. A method according to the invention comprises:
directing a particle stream towards the sample,
measuring a distribution of particles scattered from the sample as a function of at least the scattering angle, and
producing the analysis data based on the measured distribution of the scattered particles and on reference information indicative of an effect of the one or more predetermined components on the distribution of the scattered particles.

In a method according to an advantageous and non-limiting embodiment of the invention, the producing the analysis data comprises:
maintaining a model for computationally simulating a scattering process where the particle stream is directed towards a simulation model sample having a simulation model composition of the predetermined components,
simulating the scattering process with the model and varying the simulation model composition of the predetermined components until a difference between a simulated distribution of scattered particles and the measured distribution of the scattered particles fulfil a predetermined criterion, and
setting the analysis data to be the simulation model composition with which the predetermined criterion is fulfilled.

In accordance with the invention, there is provided also a new computer program for producing analysis data indicative of presence of one or more predetermined components in a sample. A computer program according to the invention comprises computer executable instructions for controlling programmable processing equipment to:
control source equipment to direct a particle stream towards the sample,
control detector equipment to measure a distribution of particles scattered from the sample as a function of at least the scattering angle, and
produce the analysis data based on the measured distribution of the scattered particles and on reference information indicative of an effect of the one or more predetermined components on the distribution of the scattered particles.

A computer program according to an advantageous and non-limiting embodiment of the invention comprises the following computer executable instructions for controlling the programmable processing to:
maintain a model for computationally simulating a scattering process where the particle stream is directed towards a simulation model sample having a simulation model composition of the predetermined components,
simulate the scattering process with the model and vary the simulation model composition of the predetermined components until a difference between a simulated distribution of scattered particles and the measured distribution of the scattered particles fulfil a predetermined criterion, and
set the analysis data to be the simulation model composition with which the predetermined criterion is fulfilled.

In accordance with the invention, there is provided also a new computer program product. The computer program product comprises a non-volatile computer readable medium, e.g. a compact disc “CD”, encoded with a computer program according to the invention.

Various exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments and their advantages are explained in greater detail below in the sense of examples and with reference to the accompanying drawings, in which:

FIG. 1 illustrates a system according to an exemplifying and non-limiting embodiment for producing analysis data indicative of presence of one or more predetermined components in a sample,

FIG. 2 illustrates a system according to another exemplifying and non-limiting embodiment for producing analysis data indicative of presence of one or more predetermined components in a sample,

FIG. 3 illustrates a system according to an exemplifying and non-limiting embodiment for producing analysis data indicative of presence of one or more predetermined components in a sample,

FIG. 4 is a high-level flowchart of a method according to an exemplifying and non-limiting embodiment for producing analysis data indicative of presence of one or more predetermined components in a sample, and

FIG. 5 is a flowchart illustrating production of analysis data on the basis of a measured scattering angle distribution of scattered particles in a method according to an exemplifying and non-limiting embodiment.

In the accompanying drawings, an underlined reference number is employed to represent an item over which the underlined number is positioned. A non-underlined reference number relates to an item identified by a line linking the non-underlined number to the item. When a reference number is non-underlined and accompanied by an associated arrow, the non-underlined reference number is used to identify a general item towards which the arrow is pointing.

### DESCRIPTION OF EXEMPLIFYING AND NON-LIMITING EMBODIMENTS

The specific examples provided in the description below should not be construed as limiting the scope and/or the applicability of the accompanied claims. All lists and groups of examples provided in the description are not exhaustive unless otherwise explicitly stated.

FIG. 1 illustrates a system 100 according to an exemplifying and non-limiting embodiment for producing analysis data indicative of presence of one or more predetermined components in a sample 110. The sample 110 comprises material to be analyzed. The material may be in a state of matter such as solid, liquid, gas, Bose-Einstein condensate, etc. In many cases, the sample is arranged in a mechanical support element that can be for example a pipe or a container arranged to contain the sample. In such instance, the sample may be liquid or gaseous. A gaseous sample may include for example natural gas, air, breath, firedamp, mine gas, and/or biogas. A liquid sample may include for example oil, blood, or liquid fuel. The mechanical support element is not shown in FIG. 1.

The system 100 comprises source equipment 120 for directing a particle stream 130 towards the sample 110. The source equipment 120 may comprise for example a neutron source. It is also possible that the source equipment comprises means for producing, instead of or in addition to a neutron stream, a stream of protons, a stream of electrons, gamma photons, and/or X-ray photons. In an exemplifying case, the neutron source is operable to generate the neutron stream by spontaneous fission of radioactive material included therein. In this exemplifying case, the neutron source may comprise a container for accommodating the radioactive material, the container having an opening for directing the neutron stream in a desired direction. Advantageously, the neutron stream emitted by the neutron source comprises neutrons having a predetermined energy distribution. The neutron source may be operable to generate substantially a predetermined number of neutrons per second. The neutron source may comprise for example Californium-252, ²⁵²Cf. A neutron source comprising Californium-252 may be operable to emit from e.g. 10⁷ to 10⁹ neutrons per second. In other exemplifying cases, the neutron source may comprise other suitable radioactive material such as for example americium-beryllium AmBe, americium-lithium AmLi, plutonium-beryllium PuBe, etc.

When the particles of the particle stream 130 interact with the sample 110, the particles may scatter or get absorbed by the sample. In cases where the particles are neutrons, the particles interact with the nuclei of atoms of the sample and the neutrons may scatter or get absorbed by the nuclei of the atoms. The system 100 comprises detector equipment 140 for measuring a distribution of particles scattered from the sample 110 as a function of at least the scattering angle. The scattering angle related to each scattered particle is an angle between an arrival direction of the particle stream 130 and a trajectory of the scattered particle under consideration. In the exemplifying situation shown in FIG. 1, the particle stream 130 is parallel with the z-axis of a coordinate system 199. A trajectory of one of the scattered particles is denoted with a reference 160 and the scattering angle of this scattered particle is denoted with θ₁. A trajectory of another scattered particle is denoted with a reference 161 and the scattering angle of this scattered particle is denoted with θ₂. The measured distribution of the scattered particles indicates how much particles are scattered to different scattering directions i.e. how the scattered particles are distributed between different scattering angles. In a system according to an exemplifying and non-limiting embodiment, the detector equipment 140 is operable to associate the scattered particles, e.g. neutrons, with a time-period of detection thereof. For example, the detector equipment 140 can be operable to measure the number of scattered neutrons as a function of the scattering angle within a given time-period such as e.g. 10 nanoseconds, one microsecond, one second, etc.

In the exemplifying case illustrated in FIG. 1, the detector equipment 140 comprises a plurality of sensors. In FIG. 1, two of the sensors are denoted with references 150 and 151. The plurality of the sensors enables detection of the scattered particles, e.g. neutrons, at various scattering angles. The detection of the scattered particles at various angles provides a good angular resolution without a need for multiple detector equipment. Furthermore, the above-mentioned arrangement of the detector equipment 140 reduces complexity, size, and cost requirements associated with the system 100. In the exemplifying case illustrated in FIG. 1, the detector equipment 140 is constructed to constitute a part of a cylindrical surface and therefore the detector equipment 140 can detect how much particles, e.g. neutrons, are scattered to different scattering directions i.e. how the scattering particles are distributed between different scattering angles measured in a geometric plane perpendicular to the axis of the cylindrical surface. In the exemplifying situation shown in FIG. 1, the scattering angles are measured in the yz-plane of the coordinate system 199. The detector equipment 140 can be arranged to surround for example a pipe that transfers sample material to be analysed. The material and wall thickness of the pipe are selected so that a sufficient portion of the particle stream is able to penetrate the pipe to reach the sample included therein and a sufficient portion of the particles scattered from the sample are as well able to penetrate the pipe.

In this document, the term “sensor” may refer to a measurement element which can be used to detect neutrons and/or other particles, and/or photons within a given solid angle element dΩ=dθ sin θdφ, where θ is a scattering angle and φ is an azimuthal angle. The above-mentioned sensor is sometimes referred as pixelated sensor or a measurement element. Pixelated sensors are sensors where a physical area of the sensor is limited to enable detecting of neutrons within a given solid angle element. If the area of a pixelated sensor is large, a small solid angle measurement can be achieved by arranging the sensor to be further away from a sample under investigation. On the other hand, if the area of the pixelated sensor is small, the pixelated sensor can be arranged to be close to the sample in order to measure neutrons within small solid angle elements.

The sensors of the detector equipment 140 are arranged at predetermined orientations on the detector equipment for example so that the individual sensors are separated from each other by an angle of 2° on the detector equipment. In this exemplifying case, the detector equipment 140 is operable to detect the scattered particles at an angular resolution of 2° with respect to direction of the incident particle stream. Optionally, the angular resolution of the detector equipment can be less than 2 degrees. However, it is to be noted that detector equipment can be arranged have a different angular resolution by changing an angular separation and possibly also the size of the sensors from each other. For example, the angular resolution of the detector equipment is in a range for 0.1 degrees to 20 degrees. The angular resolution may be for example from 0.1, 0.5, 1, 1.5, 2, 2.5, 3, 3.5, 5, 6, 7.5, 9, 10, 11, 13, 14.5, 15, 16, or 17 degrees up to 0.5, 1, 1.5, 2, 2.5, 3, 3.5, 5, 6, 7.5, 9, 10, 11, 13, 14.5, 15, 16, 17, 19, or 20 degrees.

Each sensor of the detector equipment 140 may comprise for example one or more clusters of particles of one or more scintillating materials. The one or more scintillating materials are operable to emit a photon, i.e. to produce a scintillation, in response to absorption of energy of a scattered particle e.g. a neutron. Optionally, the clusters of particles of the one or more scintillating materials are arranged on an element made of at least partially optically transparent material. In an example, the element comprises a plastic sheet. In this exemplifying case, the detector equipment may have any shape depending on the size and shape of the clusters of particles of the scintillating materials and on the size and shape of the plastic sheet. The plastic sheet and thereby the detector equipment can be arranged in a form of e.g. a partial cylinder, as illustrated in FIG. 1, or a partial sphere, or a plane. The detector equipment 140 can be configured to detect neutrons, gamma photons, X-ray photons, protons, beta particles, and/or alpha particles. For example, the sensors may comprise scintillating materials that are responsive to neutrons, gamma photons, X-ray photons, protons, beta particles, and/or alpha particles. The sensors can be operable to emit scintillation photons having different wavelengths that are characteristic to different excitations such as neutrons, protons, gamma photons, X-ray photons, beta particles, and/or alpha particles. The detector equipment may further comprise one or more photon detectors for detecting the scintillation photons emitted by the scintillating material so as to produce electric output signals. In this exemplifying case, each sensor can be a combination of one or more scintillating materials and a photon detector for detecting scintillation photons emitted by the one or more scintillating materials. It is also possible that the scintillation photons are registered for example with a camera. The camera can be configured to detect illumination, for example in the range of visible and/or infrared light, from multiple sensors at the same time.

The system 100 comprises processing equipment 170 for producing analysis data based on the measured scattering angle distribution of the scattered particles and on reference information that is indicative of an effect of one or more predetermined components, e.g. isotopes and/or chemical substances and/or compounds, on the scattering angle distribution. In a system according to an exemplifying and non-limiting embodiment, the source equipment 120 is configured to direct a neutron stream towards the sample 110, the detector equipment 140 is configured to measure the distribution of neutrons scattered from the sample as the function of the scattering angle, and the processing equipment 170 is configured to produce the analysis data based on the measured distribution of the scattered neutrons and on reference information indicative of an effect of one or more predetermined isotopes on the distribution of the scattered neutrons as the function of the scattering angle. The reference data can be based on measurements carried out with reference samples having a known isotope composition.

In an exemplifying case, the isotope composition of a carbon sample is investigated. The carbon sample is assumed to contain γ₁% ¹²C, γ₂% ¹³C, and γ₃% ¹⁴C. Thus, there is a task to determine the unknown relative abundances γ₁, γ₂, and γ₃. It is assumed that the reference information describes three reference distributions R₁₂(θ), R₁₃(θ), and R₁₄(θ) of the scattered neutrons as functions of the scattering angle θ. The reference distribution R₁₂(θ) corresponds to the situation where 100% of a sample is ¹²C, the reference distribution R₁₃(θ) corresponds to the situation where 100% of a sample is ¹³C, and the reference distribution R₁₄(θ) corresponds to the situation where 100% of a sample is ¹⁴C. It is assumed that the distribution measured for the carbon sample under analysis is S(θ). The unit of the R₁₂(θ), R₁₃(θ), R₁₄(θ), and S(θ) can be for example the number n of scattered neutrons per radian dn/dθ within a measurement time-period. The task is to define values for the unknown relative abundances γ₁, γ₂, and γ₃ so that:

γ₁R₁₂(θ)+γ₂R₁₃(θ)+γ₃R₁₃(θ)≈c S(θ), (1)

where c is an adjustable constant for enabling the sum γ₁+γ₂+γ₃ to be 100. The relative abundances γ₁, γ₂, and γ₃ can be determined for example using the least square method “LSM” so that the integral

∫[γ₁R₁₂(θ)+γ₂R₁₃(θ)+γ₃R₁₃(θ)−S(θ)]²dθ

over a suitable range of 0 is minimized. Thereafter, the relative abundances γ₁, γ₂, and γ₃ can be scaled so that γ₁+γ₂+γ₃₌₁₀₀. The scaled relative abundances γ₁, γ₂, and γ₃ constitute the analysis data indicative of presence and relative amounts of the predetermined isotopes ¹²C, ¹³C, and ¹⁴C in the analysed carbon sample. In cases where some subranges of 0 are more important than others, the above-presented function of θ being integrated can be provided with a weight function w(θ) that gives more weight on the important subranges of θ.

In a system according to an exemplifying and non-limiting embodiment, the source equipment 120 is configured to direct gamma photons to the sample 110, the detector equipment 140 is configured to detect gamma photons arriving from the sample 110, and the processing equipment 170 is configured to use, when producing the analysis data, a detection result of the gamma photons and coincidence data indicative of coincidence of the gamma photons and the scattered neutrons. The gamma photons which undergo electromagnetic interactions with atoms of the sample 110 provide complementary characteristics of the sample 110 with respect to the incident neutrons that interact directly with the atomic nuclei. Further, the gamma photons may be utilized to minimize errors and/or false measurements associated with the measurements based on the scattered neutrons. The above-mentioned coincidence data is indicative of detection of both scattered neutrons and gamma photons on the sensor equipment 140. Such coincidence data enables minimization of false measurements, such as measurements associated with gamma photons that do not originate from the neutron source, i.e. ambient gamma photons. Optionally, a time delay between the gamma photons and the scattered neutrons can be measured. In this exemplifying case, the time delay enables association of the detected gamma photons and the scattered neutrons. In another example, nuclei of atoms of the sample 110 are operable to capture a neutron to reach an excited state and, subsequently, release a gamma photon and/or an alpha particle and/or a beta particle, etc. when getting back to the ground state. In a system according to an exemplifying and non-limiting embodiment, the detector equipment 140 is configured detect alpha and/or beta particles and the processing equipment 170 is configured to use, when producing the analysis data, a detection result of the alpha and/or beta particles and information indicative of an effect of the one or more predetermined isotopes on incidence of the alpha and/or beta particles.

In a system according to an exemplifying and non-limiting embodiment, the particle stream emitted by the source equipment comprises particles having a predetermined energy distribution. For example, in a case of a neutron stream, the energy of each incident neutron can be between 10⁻¹² MeV to 10⁻⁶ MeV. The detector equipment 140 can be configured to detect energies of the scattered neutrons, and the processing equipment 170 can be configured to use, when producing the analysis data, i) the measured energies of the scattered neutrons and ii) information indicative of the effect of the one or more predetermined isotopes on the energies of the scattered neutrons. The energies of the scattered neutrons can be utilized to provide information for improving accuracy and reliability of the analysis data.

A system according to an exemplifying and non-limiting embodiment comprises at least two neutron sources for generating at least two neutron streams towards a sample being analysed. In this exemplifying case, the different neutron streams have different initial trajectories i.e. arrive from different directions at the sample. The multiple neutron sources can be used to increase for example detection sensitivity of the system.

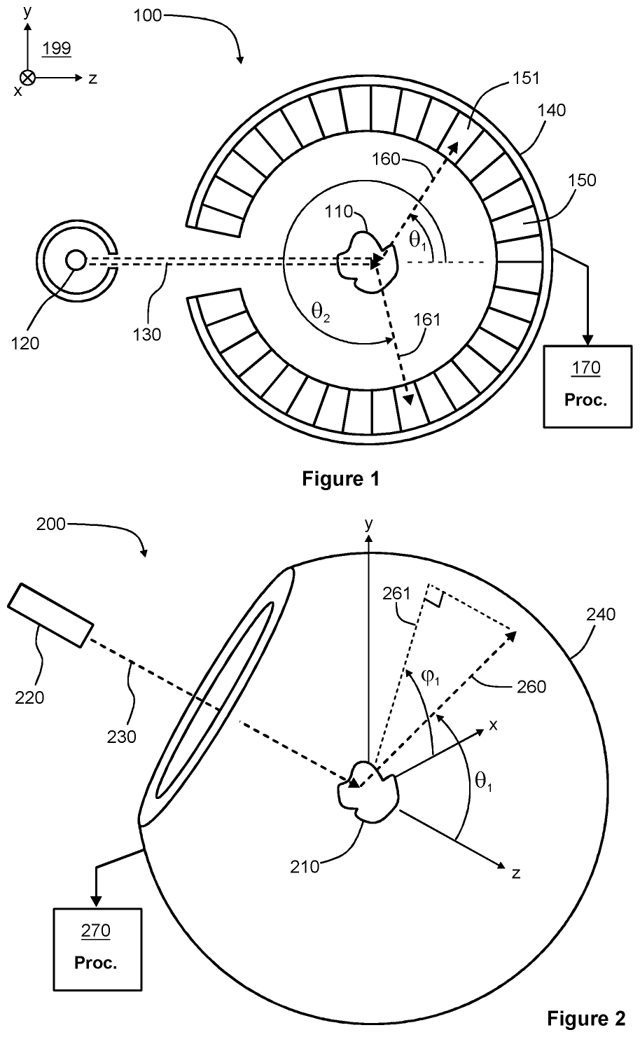

FIG. 2 illustrates a system 200 according to an exemplifying and non-limiting embodiment for producing analysis data indicative of presence of one or more predetermined components in a sample 210. The system 200 comprises source equipment 220 for directing a particle stream 230 towards the sample 210. The source equipment 220 may comprise for example a neutron source. The system 200 comprises detector equipment 240 for detecting particles scattered from the sample 210. In this exemplifying case, the detector equipment 240 has a form of a partial sphere that comprises a plurality of sensors on its inner surface. In FIG. 2, the sensors are not presented. The plurality of the sensors enables measurement of a distribution of the scattered particles as the function of the scattering angle and as a function of an azimuthal angle, too. In FIG. 2, the trajectory of one scattered particle is denoted with a reference 260 and the scattering angle of this particle is denoted with θ₁. The azimuthal angle related to each scattered particle is an angle between a projection of a trajectory of the scattered particle on a geometric plane perpendicular to the arrival direction of the particle stream and a predetermined reference direction on the geometric plane. In the exemplifying situation in FIG. 2, the above-mentioned geometric plane is the xy-plane of a Cartesian xyz-coordinate system shown in FIG. 2 and the reference direction is the x-axis of the Cartesian xyz-coordinate system. In FIG. 2, the projection of the trajectory 260 is denoted with a reference 261 and the azimuthal angle the scattered particle under consideration is denoted with φ₁.

The system 200 comprises processing equipment 270 configured to produce analysis data that is indicative of presence of one or more predetermined components in the sample 210. In this exemplifying case, each predetermined component can be an isotope variant of an elemental e.g. ¹²C, ¹³C, or ¹⁴C, a chemical substance and/or compound such as e.g. glucose C₆H₁₂O₆, ethanol C₂H₅OH, methane CH₄, or an isomer variant of a chemical compound. The processing equipment 270 is configured to produce the analysis data based on the measured distribution of the scattered particles and on reference information indicative of an effect of the one or more predetermined components on the distribution of the scattered particles.

In a system according to an exemplifying and non-limiting embodiment, the processing equipment 270 is configured to produce the analysis data based on i) the measured distribution of the scattered particles and on ii) the reference information indicative of an effect of one or more predetermined isotopes on the distribution of the scattered particles as the function of the scattering angle θ. In a system according to another exemplifying and non-limiting embodiment, the processing equipment 270 is configured to produce the analysis data based on i) the measured distribution and on ii) the reference information indicative of an effect of one or more predetermined chemical substances and/or compounds on the distribution as the function of the scattering angle θ. In a system according to an exemplifying and non-limiting embodiment, the processing equipment 270 is configured to produce the analysis data based on i) the measured distribution and on ii) the reference information indicative of an effect of one or more predetermined isomers on the distribution as the functions of the scattering angle θ and the azimuthal angle φ.

In an exemplifying case, the chemical composition of a sample is investigated. The sample is assumed to contain γ₁% methanol CH₃OH, γ₂% ethanol C₂H₅OH, and γ₃% glucose C₆H₁₂O₆. Thus, there is a task to determine the unknown percentages γ₁, γ₂, and γ₃. It is assumed that the reference information describes three reference distributions Rₘ(θ), Rₑ(θ), and R_{g}(θ) of scattered neutrons as functions of the scattering angle θ. The reference distribution Rₘ(0) corresponds to a first reference situation where a sample is methanol CH₃OH, the reference distribution Rₑ(θ) corresponds to a second reference situation where a sample is ethanol C₂H₅OH, and the reference distribution R_{g}(θ) corresponds to a third reference situation where a sample is glucose C₆H₁₂O₆. It is assumed that the distribution measured for the sample to be analysed is S(θ). The unit of the Rₘ(θ), Rₑ(θ), R_{g}(θ), and S(θ) can be for example the number n of scattered neutrons per radian dn/dθ within a measurement time-period. The task is to define values for the percentages γ₁, γ₂, and γ₃ so that:

γ₁Rₘ(θ)+γ₂Rₑ(θ)+γ₃R_{g}(θ)≈S(θ), (2)

The percentages γ₁, γ₂, and γ₃ can be determined for example with the least square method “LSM” so that the integral

∫[γ₁Rₘ(θ)+γ₂Rₑ(θ)+γ₃R_{g}(θ)−S(θ)]²dθ

over a suitable range of θ is minimized. The percentages γ₁, γ₂, and γ₃ constitute the analysis data indicative of the presence and relative amounts of methanol CH₃OH, ethanol C₂H₅OH, and glucose C₆H₁₂O₆ in the analysed sample. In cases where some subranges of θ are more important than others, the above-presented function of θ being integrated can be provided with a weight function w(θ) that gives more weight on the important subranges of θ.

Providing the above-described system with suitable reference information that is compared to the measured scattering angle distribution or scattering angle and azimuthal angle distribution of scattered particles, the system can be enabled to analyse presence of one or more of the following:
1) hormones: for example cortisol, testosterone, triiodothyronine, thyroxine, human chorionic gonadotropin, calcitosin, 17α-hydroxyprogesterone, glycoprotein polypeptide hormone, lutropin, estradiol, progesterone, androstenedione, glycoproteine hormone, somatototropin, corticotropin, prolacatin, parathyrin, aldosterone,
2) steroids: for example dehydroepiandrosterone sulfate,
3) chemical compounds such as for example creatinine, nicotine, cotinine, urea nitrogen, bilirubin, troponin, calcidiol, ammonia, phosphate, phosphorus, antigens,
4) proteins: for example c-reactive protein, hemoglobin proteins, gamma-seminoprotein, alpha fetoprotein, ferritin, albumin, globulin, myoglobin, somatomedin C, haptoblobin,
5) lipoproteins: for example low density lipoprotein LDL, high density lipoprotein HDL, very high density lipoprotein vHDL,
6) lipids such as for example triglycerides,
7) glycoproteins such as for example transferrin,
8) vitamins such as for example A, B, C, D, E, K,
9) alcohols such as for example ethanol, methanol,
10) carbohydrates such as for example glucose,
11) secosteroids such as for example vitamin D,
12) enzymes such as for example aspartate aminotransferase, alanine aminotransferase, ceuroplasmin, transaminase, phosphatase, creatine kinase, prostatic acid phosphatase,
13) ions and trace metals such as for example calcium, chloride, sodium, potassium, iron, copper, zinc, magnesium, lead,
14) gases such as for example oxygen, carbondioxide, carbonmonoxide,
15) acids such as for example bicarbonate, folic acid,
16) single cell organisms such as various bacteria,
17) light elements, such as hydrogen, boron, lithium, and heavier elements with high thermal neutron capture cross sections such as Cadmium, Gadolinium,
18) anionic detergents, alkylbenzenesulfonates, such as for example deoxycholic acid,
19) cationic detergents such as for example distearyldimethylammonium chloride “DHTDMAC”,
20) non-ionic detergents detergents such as for example Tween, Triton, and the Brij series,
21) zwitterionic detergents, such as detergents such as for example 3-[(3-cholamidopropyl) dimethylammonio]-1-propanesulfonate “CHAPS”,
22) plasticizers and dispersants,
23) calcium sulfate dihydrate,
24) substances used in de-flocculation, such as for example sodium silicate Na₂SiO₃,
25) nitrogen and sulfur mustards such as for example bis(2-chloroethyl)ethylamine,
26) arsenical such as for example ethyldichloroarsine,
27) urticants such as for example phosgene oxime,
28) metabolic and chocking poisons such as for example arsine and chlorine,
29) nerve agents such as for example sarin, novichock agents, v-series agents and saxitoxin,
30) weaponized bacteria such as for example Bacillus anthracis and these bacteria in non-military/non-weaponized cases as well,
31) weaponized viral agents such as for example ebolavirus and these viral agents in non-military/non-weaponized cases as well, and
32) Explosives in chemically pure compound or a mixture of fuel and oxidiser such as for example trinitrotoluene, triacetone triperoxide, and ammonium nitrate/fuel oil “ANFO”.

It is emphasized that the above-list contains non-limiting examples only, and the list is not exhaustive.

In an exemplifying case, the composition of isomers in a sample of chemical compound is investigated. The sample is assumed to contain γ₁% of a first isomer of the chemical compound and γ₂% of a second isomer of the chemical compound. Thus, there is a task to determine the percentages γ₁ and γ₂. It is assumed that the reference information describes two reference distributions R_{R}(θ, φ) and R_{L}(θ, φ) of scattered neutrons as functions of the scattering and azimuthal angles θ and φ. The reference distribution R_{R}(θ, φ) corresponds to a first reference situation where a sample represents the first isomer of the chemical compound, and the reference distribution R_{L}(θ, φ) corresponds to a second reference situation where a sample represents the second isomer of the chemical compound. It is assumed that the distribution measured for the sample 210 is S(θ, φ). The task is to define values for the percentages γ₁ and γ₂ so that:

γ₁R_{R}(θ,φ)+γ₂R_{L}(θ,φ)≈S(θ,φ), (3)

The percentages γ₁ and γ₂ can be determined for example with the least square method “LSM” so that the integral

∫[γ₁R_{R}(θ,φ)+γ₂R_{L}(θ,φ)−S(θ,φ)]²dθdφ

over suitable ranges of θ and φ is minimized. The percentages γ₁ and γ₂ constitute the analysis data indicative of the presence and relative amounts of the first and second isomers in the analysed sample of the chemical compound. In cases where some subareas of the two-dimensional θ, φ-space are more important than others, the above-presented function of θ and φ being integrated can be provided with a weight function w(θ, φ) that gives more weight on the important subareas.

In a system according to an exemplifying and non-limiting embodiment, the particle stream emitted by the source equipment comprises particles having a predetermined energy distribution. The detector equipment 240 can be configured to detect energies of the scattered particles, and the processing equipment 270 can be configured to use, when producing the analysis data, i) the measured energies of the scattered particles and ii) information indicative of the effect of the one or more predetermined isotopes, chemical substances and/or compounds, and/or isomers on the energies of the scattered particles. The energies of the scattered particles can be utilized to provide information for improving accuracy and reliability of the analysis data.

In a system according to an exemplifying and non-limiting embodiment, the processing equipment 270 is configured to maintain a model for computationally simulating a scattering process where the particle stream is directed towards a simulation model sample having a simulation model composition of the predetermined components, e.g. isotopes, chemical substances and/or compounds, and/or isomers. The model can be based on for example the Geant4 that is a toolkit for simulation of passage of particles through matter having different isotopes. A Geant4 model contains descriptions of the geometry of the detector equipment, the geometry of the simulation model sample, and the geometry of the intermediate space between the simulation model sample and the detector equipment. Furthermore, the model contains a description of the incident particle stream, a description of isotopic content of the detector equipment, and a description of isotopic content of the intermediate space. The isotopic content X of the simulation model sample in each simulation can be presented as a superposition of different isotopes I₁, I₂, . . . I_{N}:

X=γ₁I₁+γ₁I₁+ . . . +γ_{N}I_{N}.

where γᵢ is the relative abundance of isotope i in the simulation model sample and i=1, 2, . . . , N. In this exemplifying case, the set of the relative abundances γ₁, γ₂, . . . , γ_{N} represents the simulation model composition related to the predetermined isotopes I₁, I₂, . . . I_{N}.

Differential cross sections d²σ/cΩdE of the incident particles vs. different isotopes can be implemented within the model as external parametrizations based on separate measurements.

The processing equipment 270 is configured to simulate the scattering process with the model and vary the simulation model composition of the predetermined components, i.e. the relative abundances γ₁, γ₂, . . . γ_{N}, until a difference between a simulated distribution of scattered particles and the measured distribution of the scattered particles fulfil a predetermined criterion. The predetermined criterion can be for example that the following error square integral over a suitable range of the scattering angle θ and the azimuthal angle φ is below a given limit, i.e.

∫[M(θ,φ)−S(θ,φ)]²dθdφ<limit,

where M(θ, φ) is the simulated distribution of the scattered particles and S(θ, φ) is the measured distribution of the scattered particles.

The processing equipment 270 is configured to set the analysis data to be the simulation model composition i.e. the set of the relative abundances γ₁, γ₂, . . . , γ_{N} with which the above-mentioned predetermined criterion is fulfilled. Iterating the relative abundances γ₁, γ₂, . . . , γ_{N} i.e. the simulation model composition can be carried out for example using multivariate analysis tools such as e.g. a trained Deep Computing “DC” tools, such as e.g. a Generative Adversial Deep Neural network “GADN”, a Non-negative Matrix Factorization NMF or NNMF, or a suitable Genetic Algorithm “GA”. The starting point of the iteration can be for example the natural relative abundances of the isotopes under consideration.

Instead or in addition to analysing an isotope composition, a model-based approach of the kind described above can be used when analysis a chemical composition and/or an isomer composition of a sample. For example, the metadata of the Geant4 model comprises the differential cross sections, particle transport within materials, molar masses, Avogadro's numbers, and many other parameters that are usable in chemical and/or isomer analysis of chemical substances and compounds.

In a system according to an exemplifying and non-limiting embodiment, the processing equipment 270 is configured to compute a mass estimate corresponding to the simulation model sample based on: i) the simulation model composition expressing the relative abundances γ₁, γ₂, . . . , γ_{N} of the isotopes under consideration, ii) atomic masses of these isotopes, and on iii) amount of substance of the simulation model sample. The processing equipment 270 is configured to use a difference between the mass of the sample 210 and the computed mass estimate as a constraint when varying the simulation model composition during the iteration of the simulation model composition.

The processing equipment 170 of the system 100 can as well be configured to produce the analysis data with the above-described model-based approach. In this exemplifying case, the measured and simulated distributions are functions of only one angle-variable, i.e. the scattering angle θ.

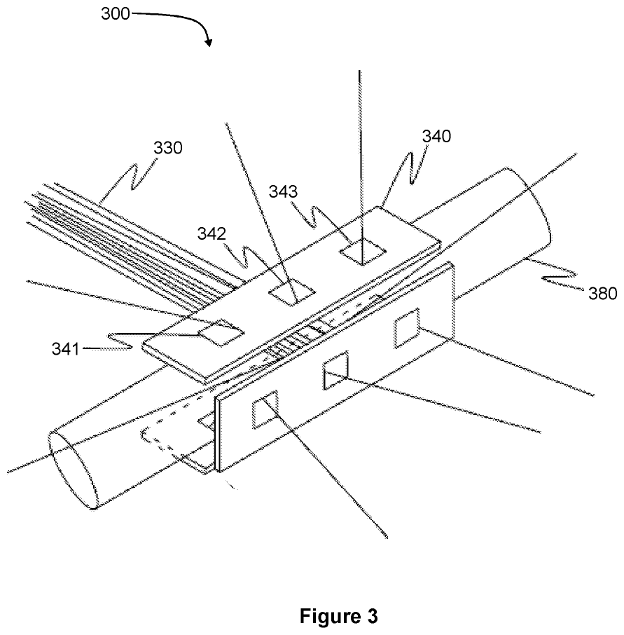

FIG. 3 shows a perspective view of a system 300 according to an exemplifying and non-limiting embodiment for producing analysis data indicative of presence of one or more predetermined components, e.g. isotopes, in a sample. The system 300 comprises a pipe 380 that includes a gaseous or liquid sample flowing there through. Furthermore, the system 300 comprises detector equipment 340 that has planar elements each comprising sensors. In FIG. 3, three of the sensors are denoted with references 341, 342, and 343. The system comprises source equipment for directing a neutron stream 330 towards the pipe 380. The source equipment is not shown in FIG. 3. As shown in FIG. 3, the sensors are arranged at different angles with respect to the neutron stream 330, thereby enabling detection of a distribution of scattered neutrons at various angles. The system 300 further comprises processing equipment for producing analysis data based on the measured distribution of the scattered neutrons and on reference information indicative of an effect of the one or more predetermined components on the distribution of the scattered neutrons. The processing equipment is not shown in FIG. 3.

The implementation of the processing equipment 170 shown in FIG. 1, as well as the implementation of the processing equipment 270 shown in FIG. 2, can be based on one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the processing equipment 170 as well as the processing equipment 270 may comprise one or more memory circuits each of which can be for example a Random-Access Memory “RAM” circuit.

A system according to an exemplifying and non-limiting embodiment is arranged in a wearable device. In an example, the wearable device is a glucose meter, i.e. a glucometer. In another example, the wearable device is configured to be coupled to a wrist of a person e.g. with a device such as a smart watch or a bracelet. For example, the wearable device is used to determine a composition of blood of a person i.e. isotopes and/or atoms and/or molecules and/or isomers the blood comprises. In an example, the determination of composition of blood of a person may comprise measurement of glucose C₆H₁₂O₆ in the blood. Determination of a high quantity of glucose such as dextrose in the blood of a person may be associated with diabetes. Such determination of quantity of glucose in the blood may enable non-invasive determination of conditions such as hyperglycaemia and/or hypoglycaemia associated with diabetes. In another example, the wearable device is arranged in a planar form. In such instance, the wearable device may be arranged on body of a person, such as e.g. the skin of a person. The wearable device can be understood broadly to be a measurement device which is temporarily placed in contact or proximity of a human being or an animal.

A system according to an exemplifying and non-limiting embodiment is arranged in a portable device. In an example, the portable device comprises a pipe to store a sample, a neutron source that is arranged to direct a neutron stream towards the sample, and detector equipment that is arranged around the pipe. In an example, the portable device can be used to analyse e.g. a composition of breath of a person. In an example, the analysis of breath includes detection of presence of volatile organic compounds “VOC”. Such detection of presence of volatile organic compounds may enable diagnosis of illnesses and/or disorders such as asthma, lung cancer, diabetes, fructose malabsorption i.e. dietary fructose intolerance, Helicobacter pylori infection, etc. In this exemplifying case, the reference information that is compared to a measured scattering angle distribution or to a measured scattering and azimuthal angle distribution may be associated with a composition of breath of healthy people such as those without the above-mentioned illnesses and/or disorders.

In a system according to an exemplifying and non-limiting embodiment, the source equipment, e.g. a neutron source, is arranged in a first mobile device and the detector equipment is arranged in a second mobile device. In an example, the first mobile device and the second mobile device are unmanned aerial vehicles “UAV”. In this exemplifying case, a particle stream from the the source equipment of the first mobile device is scattered from a sample, and the scattered particles are detected by the detector equipment of the second mobile device. In one example, such arrangement of the source equipment and the detector equipment in mobile devices enables determination of composition of soil, such as, in a location that may pose a threat to safety of humans, such as e.g. a nuclear exclusion zone.

In a system according to an exemplifying and non-limiting embodiment, the source equipment, e.g. a neutron source, and the detector equipment are arranged in a single mobile device. In an example, the mobile device comprises an internal combustion engine vehicle. In this exemplifying case, the source equipment and the detector equipment may be used to analyse a composition of a combustible fuel in a fuel tank of the internal combustion engine vehicle. For example, when the combustible fuel comprises natural gas, it is well known that a low methane number of the natural gas leads to knocking of the internal combustion engine. Further, the knocking of the internal combustion engine leads to a reduction of operating life of the engine. In this exemplifying case, the determination of composition of the combustible fuel enables to avoid such reduction of the operating life of the engine. For example, upon determination of the combustible fuel having a low methane number, an additive such as e.g. a combustible fuel having a high methane number can be added to the fuel tank.

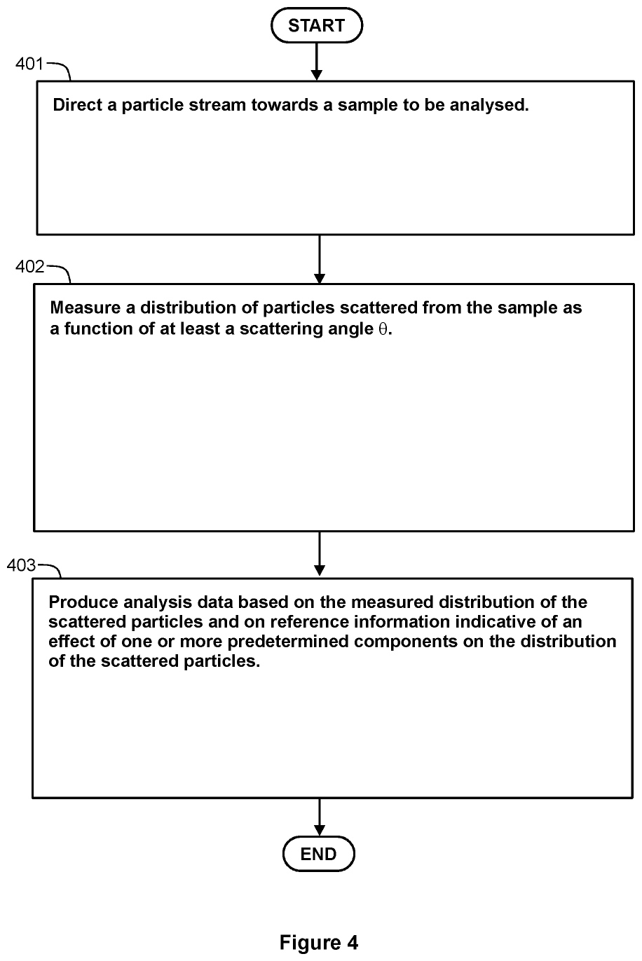

FIG. 4 is a high-level flowchart of a method according to an exemplifying and non-limiting embodiment for producing analysis data indicative of presence of one or more predetermined components, e.g. isotopes, chemical substances and/or compounds, and/or isomers, in a sample. The method comprises:

action 401: directing a particle stream towards the sample to be analysed,
action 402: measuring a distribution of particles scattered from the sample as a function of at least a scattering angle θ, the scattering angle related to each scattered particle being an angle between an arrival direction of the particle stream and a trajectory of the scattered particle under consideration, and
action 403: producing the analysis data based on the measured distribution of the scattered particles and on reference information indicative of an effect of the one or more predetermined components on the distribution of the scattered particles.

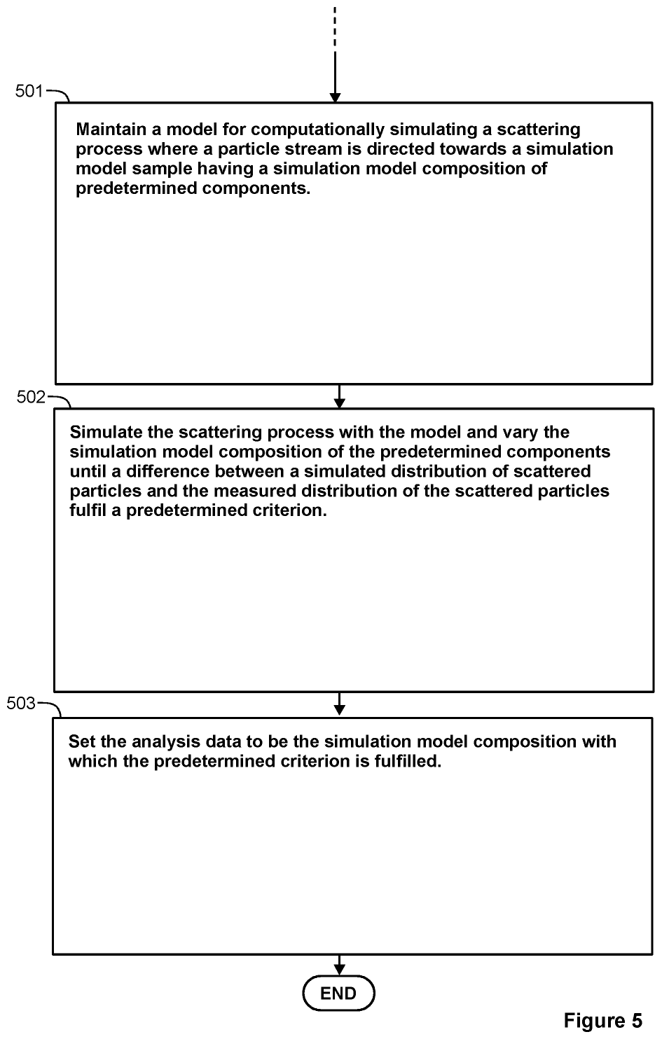

FIG. 5 is a flowchart illustrating the above-mentioned action 403 for producing the analysis data in a method according to an exemplifying and non-limiting embodiment. In this exemplifying case, the producing the analysis data comprises the following actions:
action 501: maintaining a model for computationally simulating a scattering process where the particle stream is directed towards a simulation model sample having a simulation model composition of the predetermined components,
action 502: simulating the scattering process with the model and varying the simulation model composition of the predetermined components until a difference between a simulated distribution of scattered particles and the measured distribution of the scattered particles fulfil a predetermined criterion, and
action 503: setting the analysis data to be the simulation model composition with which the predetermined criterion is fulfilled.

A method according to an exemplifying and non-limiting embodiment comprises using one of the following for seeking the simulation model composition with which the predetermined criterion is fulfilled: a Generative Adversial Deep Neural network, a Non-negative Matrix Factorization, or a Genetic Algorithm.

A method according to an exemplifying and non-limiting embodiment comprises computing a mass estimate corresponding to the simulation model sample based on: i) the simulation model composition expressing relative abundances of isotopes in the simulation model sample, ii) the atomic masses of these isotopes, and iii) amount of substance of the simulation model sample. A difference between the mass of the sample and the computed mass estimate is used as a constraint when varying the simulation model composition in an iteration process.

A method according to an exemplifying and non-limiting embodiment comprises directing a neutron stream, an alpha particle stream, a beta particle stream, and/or a proton stream towards the sample.

A method according to an exemplifying and non-limiting embodiment comprises directing gamma photons and/or X-ray photons towards the sample.

A method according to an exemplifying and non-limiting embodiment comprises detecting energies of the scattered particles. In this exemplifying case, the producing the analysis data, action 403, comprises using the measured energies of the scattered particles and information indicative of an effect of the one or more predetermined components on the energies of the scattered particles.

In a method according to an exemplifying and non-limiting embodiment, the particle stream comprises a neutron stream, the distribution of neutrons scattered from the sample is measured as the function of the scattering angle, and the analysis data is produced based on the measured distribution of the scattered neutrons and on the reference information indicative of an effect of one or more predetermined isotopes on the distribution of the scattered neutrons as the function of the scattering angle.

A method according to an exemplifying and non-limiting embodiment comprises detecting gamma photons arriving from the sample. In this exemplifying case, the producing the analysis data, action 403, comprises using a detection result of the gamma photons and coincidence data indicative of coincidence of the gamma photons arriving from the sample and the scattered neutrons.

A method according to an exemplifying and non-limiting embodiment comprises detecting alpha and/or beta particles. In this exemplifying case, the producing the analysis data, action 403, comprises using a detection result of the alpha and/or beta particles and information indicative of an effect of the one or more predetermined isotopes on incidence of the alpha and/or beta particles.

In a method according to an exemplifying and non-limiting embodiment, the analysis data is produced based on the measured distribution of the scattered particles and on the reference information indicative of an effect of one or more predetermined chemical substances and/or compounds on the distribution of the scattered particles as the function of the scattering angle.

In a method according to an exemplifying and non-limiting embodiment, the distribution of the scattered particles is measured as the function of the scattering angle θ and as a function of an azimuthal angle φ, where the azimuthal angle related to each scattered particle is an angle between a projection of a trajectory of the scattered particle under consideration on a geometric plane perpendicular to the arrival direction of the particle stream and a predetermined reference direction on the geometric plane.

In a method according to an exemplifying and non-limiting embodiment, the analysis data is produced based on the measured distribution of the scattered particles and on the reference information indicative of an effect of one or more predetermined isomers on the distribution of the scattered particles as the functions of the scattering angle and the azimuthal angle.

A computer program according to an exemplifying and non-limiting embodiment comprises computer executable instructions for controlling programmable processing equipment to carry out actions related to a method according to any of the above-described exemplifying and non-limiting embodiments.

A computer program according to an exemplifying and non-limiting embodiment comprises software modules for producing analysis data indicative of presence of one or more predetermined components in a sample. The software modules comprise computer executable instructions for controlling programmable processing equipment to:
control source equipment to direct a particle stream towards the sample,
control detector equipment to measure a distribution of particles scattered from the sample as a function of at least the scattering angle, and
produce the analysis data based on the measured distribution of the scattered particles and on reference information indicative of an effect of the one or more predetermined components on the distribution of the scattered particles.

In a computer program according to an exemplifying and non-limiting embodiment, the software modules comprise the following computer executable instructions for controlling the programmable processing equipment to:
maintain a model for computationally simulating a scattering process where the particle stream is directed towards a simulation model sample having a simulation model composition of the predetermined components,
simulate the scattering process with the model and vary the simulation model composition of the predetermined components until a difference between a simulated distribution of scattered particles and the measured distribution of the scattered particles fulfil a predetermined criterion, and
set the analysis data to be the simulation model composition with which the predetermined criterion is fulfilled.

The software modules can be for example subroutines or functions implemented with programming tools suitable for the programmable processing equipment.

A computer program product according to an exemplifying and non-limiting embodiment comprises a computer readable medium, e.g. a compact disc “CD”, encoded with a computer program according to an exemplifying embodiment.

A signal according to an exemplifying and non-limiting embodiment is encoded to carry information defining a computer program according to an exemplifying embodiment.

The specific examples provided in the description given above should not be construed as limiting the scope and/or the applicability of the appended claims. Lists and groups of examples provided in the description given above are not exhaustive unless otherwise explicitly stated.

1. A system for producing analysis data indicative of presence of one or more predetermined components in a sample, the system comprising:
source equipment for directing a particle stream towards the sample,
detector equipment for measuring a distribution of particles scattered from the sample as a function of at least a scattering angle, the scattering angle related to each scattered particle being an angle between an arrival direction of the particle stream and a trajectory of the scattered particle under consideration, and
processing equipment for producing the analysis data based on the measured distribution of the scattered particles and on reference information indicative of an effect of the one or more predetermined components on the distribution of the scattered particles, wherein the processing equipment is configured to:
maintain a model for computationally simulating a scattering process where the particle stream is directed towards a simulation model sample having a simulation model composition of the predetermined components,
simulate the scattering process with the model and vary the simulation model composition of the predetermined components until a difference between a simulated distribution of scattered particles and the measured distribution of the scattered particles fulfil a predetermined criterion, and
set the analysis data to be the simulation model composition with which the predetermined criterion is fulfilled.

2. (canceled)

3. A system according to claim 1, wherein the processing equipment is configured to use one of the following for seeking the simulation model composition with which the predetermined criterion is fulfilled: a Generative Adversial Deep Neural network, a Non-negative Matrix Factorization, a Genetic Algorithm.

4. A system according to claim 1, wherein the source equipment is configured to direct towards the sample at least one of: a neutron stream, an alpha particle stream, a beta particle stream, a proton stream.

5. A system according to claim 1, wherein the source equipment is further configured to direct towards the sample at least one of: gamma photons, X-ray photons.

6. A system according to claim 1, wherein the detector equipment is configured to detect energies of the scattered particles and the processing equipment is configured to use, when producing the analysis data, the measured energies of the scattered particles and information indicative of an effect of the one or more predetermined components on the energies of the scattered particles.

7. A system according to claim 1, wherein the source equipment is configured to direct a neutron stream towards the sample, the detector equipment is configured to measure the distribution of neutrons scattered from the sample as the function of the scattering angle (θ₁, θ₂), and the processing equipment is configured to produce the analysis data based on the measured distribution of the scattered neutrons and on the reference information indicative of an effect of one or more predetermined isotopes on the distribution of the scattered neutrons as the function of the scattering angle.

8. A system according to claim 7, wherein the processing equipment is configured to compute a mass estimate corresponding to the simulation model sample based on: i) the simulation model composition expressing relative abundances of the predetermined isotopes in the simulation model sample, ii) atomic masses of the predetermined isotopes, and iii) amount of substance of the simulation model sample, and to use a difference between mass of the sample and the computed mass estimate as a constraint when varying the simulation model composition.

9. A system according to claim 7, wherein the detector equipment is configured to detect gamma photons arriving from the sample, and the processing equipment is configured to use, when producing the analysis data, a detection result of the gamma photons and coincidence data indicative of coincidence of the gamma photons and the scattered neutrons.

10. A system according to claim 7, wherein the detector equipment is configured detect alpha particles, and the processing equipment is configured to use, when producing the analysis data, a detection result of the alpha particles and information indicative of an effect of the one or more predetermined isotopes on incidence of the alpha particles.

11. A system according to claim 7, wherein the detector equipment is configured detect beta particles, and the processing equipment is configured to use, when producing the analysis data, a detection result of the beta particles and information indicative of an effect of the one or more predetermined isotopes on incidence of the beta particles.

12. A system according to claim 1, wherein the processing equipment is configured to produce the analysis data based on the measured distribution of the scattered particles and on the reference information indicative of an effect of one or more predetermined chemical substances or compounds on the distribution of the scattered particles as the function of the scattering angle.

13. A system according to claim 1, wherein the detector equipment is configured to measure the distribution of the scattered particles as the function of the scattering angle and as a function of an azimuthal angle the azimuthal angle related to each scattered particle being an angle between a projection of a trajectory of the scattered particle under consideration on a geometric plane perpendicular to the arrival direction of the particle stream and a predetermined reference direction on the geometric plane.

14. A system according to claim 13, wherein the processing equipment is configured to produce the analysis data based on the measured distribution of the scattered particles and on the reference information indicative of an effect of one or more predetermined isomers on the distribution of the scattered particles as the functions of the scattering angle and the azimuthal angle.

15. A method for producing analysis data indicative of presence of one or more predetermined components in a sample, the method comprising:
directing a particle stream towards the sample,
measuring a distribution of particles scattered from the sample as a function of at least a scattering angle the scattering angle related to each scattered particle being an angle between an arrival direction of the particle stream and a trajectory of the scattered particle under consideration, and
producing the analysis data based on the measured distribution of the scattered particles and on reference information indicative of an effect of the one or more predetermined components on the distribution of the scattered particles, wherein the producing the analysis data comprises:
maintaining a model for computationally simulating a scattering process where the particle stream is directed towards a simulation model sample having a simulation model composition of the predetermined components,
simulating the scattering process with the model and varying the simulation model composition of the predetermined components until a difference between a simulated distribution of scattered particles and the measured distribution of the scattered particles fulfil a predetermined criterion, and
setting the analysis data to be the simulation model composition with which the predetermined criterion is fulfilled.

16. (canceled)

17. A method according to claim 15, wherein the method comprises using one of the following for seeking the simulation model composition with which the predetermined criterion is fulfilled: a Generative Adversial Deep Neural network, a Non-negative Matrix Factorization, a Genetic Algorithm.

18. A method according to claim 15, wherein the method comprises directing towards the sample at least one of: a neutron stream, an alpha particle stream, a beta particle stream, a proton stream.

19. A method according to claim 15, wherein the method comprises directing towards the sample at least one of: gamma photons, X-ray photons.

20-28. (canceled)

29. A non-volatile computer readable medium encoded with a computer program for producing analysis data indicative of presence of one or more predetermined components in a sample, the computer program comprising computer executable instructions for controlling programmable processing equipment to:
control source equipment to direct a particle stream towards the sample,
control detector equipment to measure a distribution of particles scattered from the sample as a function of at least a scattering angle, the scattering angle related to each scattered particle being an angle between an arrival direction of the particle stream and a trajectory of the scattered particle under consideration, and
produce the analysis data based on the measured distribution of the scattered particles and on reference information indicative of an effect of the one or more predetermined components on the distribution of the scattered particles, wherein the computer program comprises computer executable instructions for controlling the programmable processing equipment to:
maintain a model for computationally simulating a scattering process where the particle stream is directed towards a simulation model sample having a simulation model composition of the predetermined components,
simulate the scattering process with the model and vary the simulation model composition of the predetermined components until a difference between a simulated distribution of scattered particles and the measured distribution of the scattered particles fulfil a predetermined criterion, and
set the analysis data to be the simulation model composition with which the predetermined criterion is fulfilled.

30-31. (canceled)
